(19) United States
(12) Patent Application Publication
(10) Pub. No.: US 2007/0144601 A1
(43) Pub. Date: Jun. 28, 2007

(54) MEASURING TRACTION FORCES

(76) Inventor: Roderick Charles Brewis, Frome (GB)

Correspondence Address: STITES & HARBISON PLLC, 1199 NORTH FAIRFAX STREET, SUITE 900, ALEXANDRIA, VA, 22314, US

(21) Appl. No.: 11/538,483

(22) Filed: Oct. 4, 2006

(30) Foreign Application Priority Data
Oct. 4, 2005 (GB) 0520182.7

(51) Int. Cl. F16L 33/00; F16L 55/16; F16L 55/18

(52) U.S. Cl. 138/98; 405/184.3

(57) ABSTRACT

A pipe towing head incorporates a load cell (30) for monitoring traction forces applied to the pipe. A central tubular bolt (10( ) has a coupling eye (12,14) at the front end, and a threaded (22) rear end, coupled to a tailpiece (24). An annular expandable pipe-gripping assembly (44), including an expander (28), is mounted on the bolt (10). The load cell (30) is axially between the tailpiece (24) and the expander (28). The expander (28) is threadedly engaged with an element (36) rotationally fast with the bolt (10). Rotation of the bolt displaces the expander (28) to cause expansion, and displaces the tailpiece equally. Traction applied to the eye (12,14) is transmitted to the tailpiece

### FIELD OF THE INVENTION

The present invention relates to measuring traction forces, particularly those involved in processes such as pipe pulling. In various aspects it relates to a measuring method, and an assembly incorporating means for measuring traction.

Existing gas, water and sewage pipes and other ducts may be refurbished by pulling a smaller plastic pipe through the old duct. A pipe of the same size or larger may be inserted by the Pipe Bursting Technique, wherein the existing pipe is split and expanded using a hydraulic ram, splitting blade and expander, the new pipe being pulled in behind the expander. New installations in virgin ground may be installed using the Directional Drilling Technique. In all three cases, it is desirable for the load to be monitored and recorded to show that the maximum permissible load for the size of pipe has not been exceeded.

### SUMMARY OF THE INVENTION

One type of embodiment of the present invention is a pipe end fitting, for use in pulling polyethylene or other pipes through the ground, and incorporating a load cell which experiences a load related to the applied traction.

Thus the invention provides an assembly for engaging an end region of a hollow body such as a pipe for applying traction thereto, said assembly comprising:

an elongate axial element having coupling means at one end for the application of traction;

a tail piece which in use is axially fast with the axial element at the other end region;

annular body-engaging means which in use is mounted on the axial element and capable of axial displacement relative to it, and which has a radially outer region for engaging an internal surface of a hollow body;

an annular load cell which in use is mounted on the axial element intermediate the tail piece and the body-engaging means;

the arrangement being such that when a hollow body is engaged by the body engaging means and traction is applied to the coupling means, the tail piece is urged towards the body engaging means and applies force to it via the load cell.

The body engaging means may comprise a radially expandable section (e.g. comprising a plurality of sectoral elements, possibly encircled by resilient bands such as O-rings) and an expander element displaceable towards and into the expandable section to urge expansion.

The body engaging means may be mounted on a tubular drawbolt which is axially displaceable on the elongate axial element, but rotationally fast with it.

The expander element may have an internal thread which engages an external thread which is rotatable to urge displacement of the expander element. It may be rotatable by rotation of the elongate axial element. It may be provided by the tubular drawbolt (if present). There may be a corresponding pair of threads coupling the tail piece to the elongate axial element. Thus rotation of that element urges equal axial displacements of the tail piece and the expander element, so that it does not substantially cause or reduce compressive loading on the load cell.

The assembly may include a recording device and/or a transmitter coupled to the load cell, suitably housed in a housing mounted on the tail piece.

In another aspect the invention provides a method of measuring traction applied to a hollow body by means of an assembly as described above.

An embodiment of the invention will now be described by way of example with reference to the accompanying drawings.

### BRIEF DESCRIPTION OF THE DRAWINGS

FIG. 1 is a view, mainly in axial section, showing a load sensor towing head which is an assembly embodying the invention; and

FIGS. 2-5 are radial sections through various components of FIG. 1, FIG. 2 showing the tail piece, FIG. 3 showing the annular load cell, FIG. 4 showing the coupling of the tubular drawbolt to the elongate axial element, and FIG. 5 showing the end region of the elongate axial element, at the coupling means, and also showing the region for coupling to the tubular drawbolt.

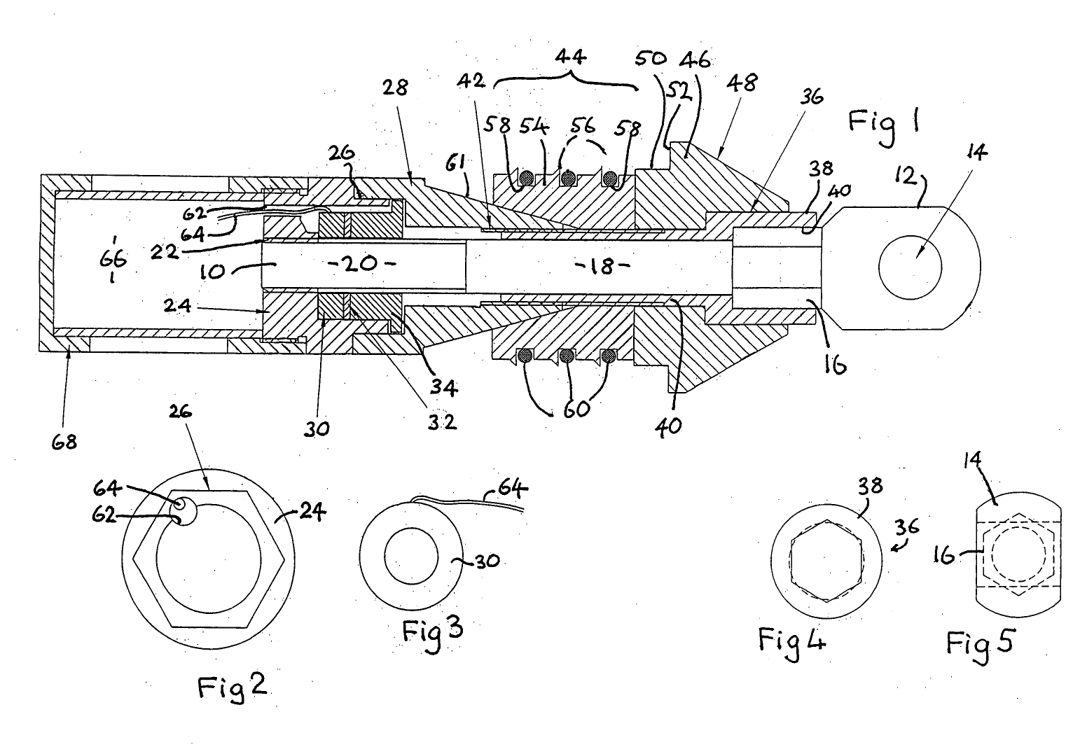

### DESCRIPTION OF THE PREFERRED EMBODIMENT

The assembly includes an elongate axial element 10. At the “front end”, this has an enlarged coupling portion 12 which, in this example, is shown as an eye-bolt, with an opening 14. Adjacent this enlarged portion, there is a section 16 of hexagonal section. Beyond this, there is a long cylindrical section 18 of lesser diameter, followed by a cylindrical section 20 which is of slightly smaller diameter, the final portion of which has an external thread 22.

A tail piece 24 is an annular element with an internal thread which engages on the thread 22 on the end section 20 of the axial element 10. The tail piece 24 is cup-shaped, the cup opening forwardly (that is, towards the eye bolt 12). At its front end, it is stepped, leading to a front portion 26 with a hexagonal outer surface. The step abuts an expander element 28, which has an annular portion with a hexagonal inner surface that engages slidably over the hexagonal outer surface 26 of the tail piece 24. Within the “cup” of the tail piece 24, there is an annular load cell element 30, in contact with the base of the cup. On its front axial face, this element 30 contacts a compression washer 32, which abuts a spacer member 34, which abuts an axial face provided on the expander element 28.

A tubular drawbolt is mounted over the axial element 10. It has an enlarged front portion 38 with a hexagonal inner surface 40 which fits slidably on the hexagonal surface 16 of the axial element 10. To the rear, the drawbolt has an elongate reduced diameter section 40 which has an external thread 42 which has the same pitch as the threads on the tail piece 24 and the rear section of the axial element 10.

An annular body-engaging (in this embodiment, pipe-engaging) means is constituted by the expander element 28, an expandable assembly 44, and a nose piece 46. The nose piece 46 has a tapered front surface 48, shaped to ease the path of a pipe being towed though the ground. At the rear side, the nose piece 46 has a cylindrical spigot portion 50 terminating at the front in a shoulder 52, for engagement of the end of a pipe to be pulled.

Immediately to the rear of the nose piece 46, and abutting it in use, is the expandable assembly 44. This has an external diameter which, prior to expansion, is similar to that of the spigot 50 of the nose piece 46. In generally known fashion, the expandable assembly 44 is constituted by a plurality (e.g. four) of separate sectoral pieces which, together, constitute a hollow cylinder, with axial gaps. The pieces have external teeth 56 for engaging the internal surface of a pipe. They have radial channels 58 which house resilient O-rings 60 which hold the individual pieces 54 together as a cylinder, and resist expansion.

The expander element 28 has a gradually tapering conical wedge or cam surface 61 that extends partly within the expandable assembly 44, which has a correspondingly shaped internal surface. Thus forward movement of the expander element 28 relative to the expandable assembly 44 urges radial expansion thereof.

The tail piece 24 has an axial bore 62 extending rearwardly, for a cable 64 for carrying data from the load cell 30. The cable 64 passes to an axial cavity to the rear of the tail piece 24, within a housing 68 which is coupled to the tail piece and has an external diameter which is the same as that of the tail piece, which is the same as that of the rear, cylindrical portion of the expander element 28.

To assemble the device for use, the load cell 30 and the compression washer 32 are positioned between the tail piece 24 and the axial element 10. The components of the body-engaging means are passed onto the axial element, and the tail piece 24 is positioned so that it abuts the rear of the expander element 28. It becomes rotationally fast with it, through engagement of the hexagonal surfaces.

The load cell 34 is connected to a recording and transmitting device (not shown) in the container 68, via the cable 64.

The expander element 28 is screwed onto the thread 42 on the drawbolt 40, and the tail piece 24 is screwed onto the thread 22 on the rear section of the axial element 10.

The assembly is passed into a pipe, rear end first, until the end of the pipe abuts the shoulder 52 on the nose piece. The axial element 10 is rotated (by rotation of the eye bolt 12). This rotates the drawbolt 36, thus urging the expansion element 28 into the expandable assembly 44, urging the sectoral elements 54 radially outwardly, to grip the pipe. The rotation of the axial element also causes the tail piece 24 to advance at the same rate as the expander element 28, so that no compressive load is applied to the load cell 30.

The device may then be shackled to a winch cable or other motive device via the eye hole 14. When an axial load is applied thereby to the eye bolt 12, the tail piece 24 is drawn forward. Force which is applied from this to the expander element 28 has to be transmitted through the load cell 30, which thus registers the applied load.

Whereas the invention has been described in the context of a simple towing head, it is equally applicable to mudtight towing heads, e.g. as disclosed in my European patent specification EP-A-1 211 454.

While the invention has been described above by reference to the preferred embodiment, it will be understood by those skilled in the art that various changes and modifications may be made without departing from the spirit scope and the invention. It is intended to cover all such changes and modifications by the appended claims.

1. A traction assembly for engaging an end region of a hollow body for applying traction thereto, said assembly comprising:
an elongate axial element having first and second opposite end regions, and including a coupling device at said first end region for the application of traction;
a tail piece which in use is axially fast with the axial element at said second end region so that traction applied to said coupling means is transmitted to said tail piece;
an annular body-engaging assembly which in use is mounted on the axial element and capable of axial displacement relative to it, and which has a radially outer region for engaging an internal surface of a hollow body; and
an annular load cell which in use is mounted on the axial element intermediate the tail piece and the body-engaging assembly;
the arrangement being such that when a hollow body is engaged by the body engaging assembly and traction is applied to the coupling device, the tail piece is urged towards the body engaging assembly and applies force to it via the load cell.

2. A traction assembly according to claim 1 wherein said body engaging assembly includes a tubular drawbolt which is axially displaceable on the elongate axial element, but rotationally fast with it.

3. A traction assembly according to claim 1 wherein said body engaging assembly comprises a radially expandable section and an expander element displaceable towards and into the expandable section to urge expansion.

4. A traction assembly according to claim 3 wherein said expander element has an internal thread, and the assembly includes a rotatable element having an external thread which engages said internal thread of said expander element so that said rotatable element is rotatable to urge displacement of the expander element.

5. A traction assembly according to claim 4 wherein said rotatable element is coupled to said elongate axial element so as to be rotable by rotation thereof.

6. A traction assembly according to claim 5 wherein said rotable element is a tubular drawbolt which is axially displaceable on the elongate axial element, but rotationally fast with it.

7. A traction assembly according to claim 5 wherein said tail piece and said elongate axial element have respective threads by which they are mutually coupled, said threads having the same pitch as the threads by which the expanded element and rotatable element are mutually coupled, so that rotation of said axial element urges equal axial displacement of the tail piece and the expander element, so that it does not substantially cause or reduce compressive loading on the load cell.

8. A traction assembly according to claim 1, further including a data receiving device coupled to the load cell.

9. A traction assembly according to claim 8 wherein said data receiving device is housed in a housing mounted on the tail piece.

10. A traction assembly according to claim 8 wherein said data receiving device comprises one or more of a data recorder and a transmitter.

11. A method of measuring traction applied to a hollow body comprising:
a) providing an assembly comprising:
an elongate axial element having first and second opposite end regions, and including a coupling device at said first end region for the application of traction;
a tail piece which in use is axially fast with the axial element at said second end region so that traction applied to said coupling device is transmitted to said tail piece;
an annular body-engaging assembly which in use is mounted on the axial element and capable of axial displacement relative to it, and which has a radially outer region for engaging an internal surface of a hollow body; and
an annular load cell which in use is mounted on the axial element intermediate the tail piece and the body-engaging assembly;
(b) coupling said traction assembly to the hollow body by means of its annular body-engaging assembly;
(c)applying traction via said coupling device; and
(d)monitoring the annular load cell.
